(19) United States
(12) Patent Application Publication
(10) Pub. No.: US 2026/0200374 A1
(43) Pub. Date: Jul. 16, 2026

(54) HINGE MECHANISM

(71) Applicant: FAURECIA Sièges d'Automobile, NANTERRE (FR)

(72) Inventor: Sébastien LECONTE, FLERS (FR)

(21) Appl. No.: 19/448,544

(22) Filed: Jan. 14, 2026

(30) Foreign Application Priority Data
Jan. 15, 2025 (FR) 2500420

(51) Int. Cl. B60N 2/22

(52) U.S. Cl. CPC B60N 2/2213

(57) ABSTRACT

The present disclosure relates to a hinge mechanism for a seat comprising a movable flange comprising a plate and an inner ring gear, the inner ring gear being centered on a first axis, and a fixed flange comprising an outer ring gear centered on a second axis parallel to the first axis and meshing with the inner ring gear of the movable flange, the outer ring gear comprising, on an inner side, a bearing face which bears axially on the plate, wherein the outer ring gear comprises, on the inner side, a deformation extending at least partially over its periphery so that a peripheral edge of the outer ring gear is at least partially at a distance from the plate.

### PRIORITY CLAIM

This application claims priority to French Patent Application No. FR2500420, filed January 15, 2025, which is expressly incorporated by reference herein.

### BACKGROUND

The present disclosure relates to a seat hinge mechanism for adjusting the backrest inclination, in particular of the continuously adjustable type. The present description also relates to a seat, particularly a motor vehicle seat, comprising such a hinge mechanism. The present description further relates to a method of manufacturing a fixed flange for such a hinge mechanism.

### SUMMARY

According to the present disclosure, a hinge mechanism for a seat comprises:

a movable flange comprising a plate and an inner ring gear, the inner ring gear being centered on a first axis,

a fixed flange comprising an outer ring gear centered on a second axis parallel to the first axis and meshing with the inner ring gear of the movable flange, the outer ring gear comprising, on an inner side, a bearing face which bears axially on the plate,

wherein the outer ring gear comprises, on the inner side, a deformation extending at least partially over its periphery so that a peripheral edge of the outer ring gear is at least partially at a distance from the plate.

The outer ring gear may comprise a peripheral deformation on the inner side, such that a peripheral edge of the outer ring gear is entirely at a distance away from the plate.

The peripheral deformation on the inner side of the outer ring gear may comprise a peripheral recess.

The peripheral recess can have a peripheral face, the peripheral face being axially set back from the bearing face with respect to the plate.

The outer ring gear may comprise, on the inner side, an edge connecting the bearing face to the peripheral face, the edge extending along the periphery of the outer ring gear following the profile of the teeth.

The peripheral deformation can form a band around the inner side of the outer ring gear with a width of between 0.1 mm and 1 mm.

The deformation can be localized at each tooth flank of the teeth of the outer ring gear.

The outer ring gear may have a thickness that is smaller radially at the deformation than radially at the bearing face.

The peripheral edge of the ring gear can be wholly or partially at an axial distance from the plate of between 0.1 mm and 0.5 mm, preferably between 0.2 mm and 0.4 mm.

According to another aspect, a vehicle seat is proposed, particularly for a motor vehicle, comprising the hinge mechanism as described above.

According to another aspect, a method for manufacturing a fixed flange for a seat hinge mechanism is proposed, the method comprising:

Cutting a flat metal blank to form an outer ring gear of the fixed flange, which comprises, on an inner side, a bearing face that is intended to bear axially on a plate of a movable flange that comprises an inner ring gear meshing with the outer ring gear,

Applying pressure to a peripheral zone of the inner side of the outer ring gear so as to create, on the inner side, a peripheral deformation intended to move a peripheral edge of the outer ring gear away from the plate when the bearing face is axially bearing on a plate of a movable flange which comprises an inner ring gear meshing with the outer ring gear.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic cross-sectional view that represents a comparative seat hinge mechanism.

FIG. 2 is a schematic cross-sectional view showing a fine-cutting method.

FIG. 3 a schematic cross-sectional view showing a burr on a ring gear of the comparative hinge mechanism shown in FIG. 1.

FIG. 4a is a partial schematic perspective view showing interference between a first flange and a second flange resulting from the presence of the burr shown in FIG. 3.

FIG. 4b is a larger-scale view of the interference zone.

FIG. 5 is a perspective exploded view of a hinge mechanism according to the present description.

FIG. 6 is an exploded view of a movable flange and a fixed flange of the hinge mechanism shown in FIG. 5.

FIG. 7 is a partial schematic cross-sectional view of the hinge mechanism of FIG. 5.

FIG. 8 is a front view of the fixed flange of the hinge mechanism shown in FIG. 5.

FIG. 9 is a larger-scale view of the zone in dotted lines in FIG. 8.

FIG. 10 is a partial perspective schematic illustrating the spaced arrangement of a peripheral edge of an outer ring gear of the fixed flange relative to the movable flange in the mechanism shown in FIG. 5.

FIG. 11 is a schematic side view of a seat with a hinge mechanism as shown in FIG. 5.

FIG. 12 is a front view of the fixed flange of the hinge mechanism shown in FIG. 5, according to a variant.

FIG. 13 is a larger-scale view of the zone in dotted lines in FIG. 12.

### DETAILED DESCRIPTION

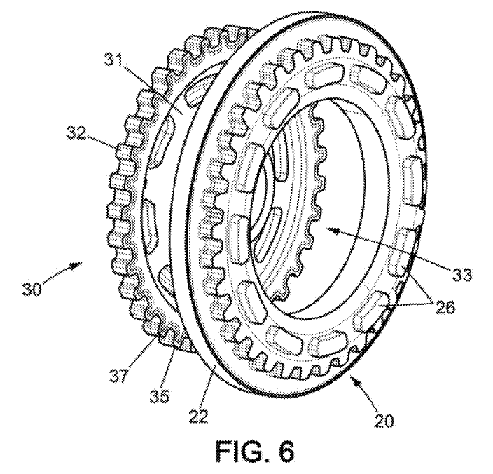

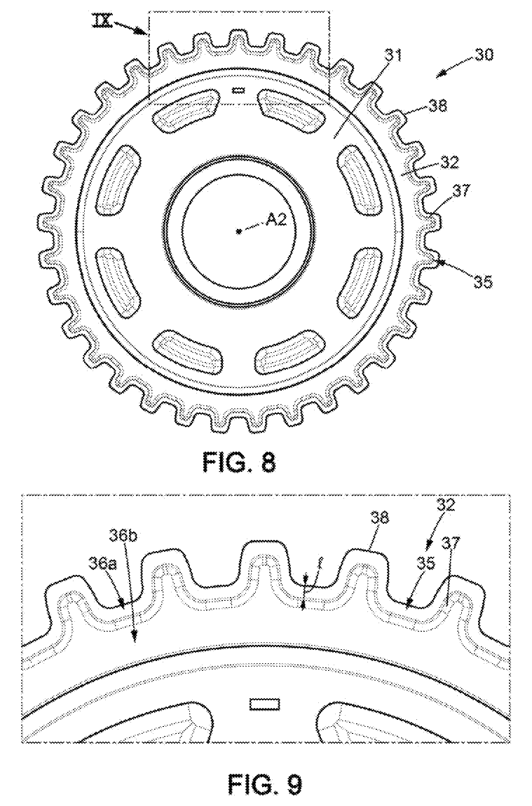

With reference to FIGS. 5 to 10, a hinge mechanism is now described, in particular for continuously adjusting the backrest of a vehicle seat.

In the following, orientation qualifiers attributed to an element, such as "longitudinal", "radial" or "circumferential", are defined unless otherwise specified by reference to the corresponding axis of the element, either the first A1 or second axis. In particular, the first axis A1 is relative to the movable flange 20 and the second axis A2 is relative to the fixed flange 30. A radial direction is a direction perpendicular to the direction of the corresponding axis. A circumferential direction, at a point away from the corresponding axis, corresponds to a direction perpendicular to the axial and radial directions. Moreover, unless otherwise specified, the adjectives “interior”, “inner”, “exterior” and “outer” are used with reference to a radial direction such that the interior/inner part, that is to say radially interior/inner part, of an element is closer to the corresponding axis than the exterior/outer part, that is to say radially exterior/outer part, of the same element.

In the following description, when referring to absolute position qualifiers, such as “front,” “rear,” “top,” “bottom,” “left,” “right,” etc., or to relative position qualifiers, such as “above,” “below,” “upper,” “lower,” etc., or to qualifiers of orientation, such as “horizontal,” “vertical,” etc., reference is made, unless otherwise specified, to the orientation of the figures or of a seat in its normal usage position.

The longitudinal direction X is understood to mean the longitudinal direction X of a seat. The longitudinal direction X of the seat 60 is considered to be the same as the longitudinal direction X of the motor vehicle in which the seat 60 is mounted. This longitudinal direction X corresponds to the normal direction in which the vehicle advances. The longitudinal direction X is preferably horizontal. The transverse direction Y is the transverse direction Y of the seat 60. The transverse direction Y of the seat thus corresponds to the transverse Y or lateral direction of the motor vehicle. This transverse direction Y corresponds to a direction perpendicular to the normal direction of travel of the vehicle. The transverse direction Y is preferably horizontal. Finally, the vertical direction Z is a vertical direction of the seat, perpendicular to the longitudinal X and transverse Y directions.

The hinge mechanism 10 comprises a movable flange 20 and a fixed flange 30. The movable flange 20 and the fixed flange 30 can each be generally disc-shaped. In this sense, the movable flange 20 and the fixed flange 30 can be discoid.

The movable flange 20 comprises a plate 21. The movable flange 20 further comprises an inner ring gear 22. The inner ring gear 22 is centered on a first axis A1. The inner ring gear 22 comprises an annular row of teeth (i.e. a gear toothing) each extending radially inwards. The inner ring gear 22 and the plate 21 of the movable flange 20 may be integral with each other. The movable flange 20 may comprise a flared annular wall 23 connecting the inner ring gear 22 and the plate 21. The flared annular wall 23 may have a rounded inner face 24 (i.e. forming a fillet). “Inner” means mean the axially-facing face of the fixed flange 30. Such a flared annular wall 23 may be the result of shaping the movable flange 20 by stamping or pressing.

The fixed flange 30 comprises an outer ring gear 32 centered on a second axis A2 parallel to the first axis A1. The second axis A2 can be offset relative to the first axis A1. In other words, the first axis A1 and the second axis A2 can be distinct (i.e. not merged). The outer ring gear 32 comprises an annular row of teeth (i.e. a gear toothing) each extending radially outwards. The toothing of the movable flange 20 and the fixed flange 30 can be obtained by fine cutting, that is a succession of stamping operations starting from a flat metal blank or sheet and ending with the forming of the flange as presented.

As can be seen, the fixed flange 30 can also include a plate 31. The fixed flange 30 may further comprise a flared annular wall 34 connecting the outer ring gear 32 and the respective plate 31. Such a flared annular wall 34 may be the result of shaping the fixed flange 30 by stamping or pressing.

The outer ring gear 32 meshes with the inner ring gear 22 of the movable flange 20. When it is said that the inner ring gear 22 meshes with the outer ring gear 32, it is understood that one or more teeth of the inner ring gear mesh with one or more teeth of the outer ring gear 32. As far as the engagement zone is concerned, there may be actual physical contact between two teeth simultaneously. This forms a very robust mechanical interface. The engagement zone moves as the movable flange 20 moves relative to the fixed flange 30.

The inner ring gear 22 may have a greater number of teeth than the outer ring gear 32. For example, the inner ring gear 22 may comprise 34 teeth and the outer ring gear 32 may comprise 33 teeth. The number of teeth can be different. More generally, the difference in the number of teeth may be 1, without ruling out a difference of 2 or more.

The fixed flange 30 and the movable flange 20 can therefore be rotatably mounted relative to each other and connected by a hypocycloid gear mechanism resulting from the engagement of the inner ring gear 22 and the outer ring gear 32. The terms "fixed" and "movable" are used here to distinguish between flanges, since, depending on one's point of view, a first flange can be considered movable relative to a second flange considered fixed, and conversely the second flange can be considered movable relative to the first flange considered fixed. Also, its terms "fixed" and "movable" are used interchangeably in this description, without altering or modifying the scope or interpretation deriving from the provisions described.

In a particular example, the movable flange 20 can be configured to be attached to a backrest 62 of a seat 60, in particular a vehicle seat 60, and the fixed flange 30 can be configured to be attached to a squab 61 of a seat 60. The hinge mechanism 10 can be configured to adjust the inclination of a seat 60 backrest 62 relative to a seat 60 squab 61, in particular of a vehicle seat 60, especially for motor vehicles.

The plate 21 and inner ring gear 22 can define a housing 25, in particular a cylindrical one. The outer ring gear 32 can be received, in whole or in part, in the housing 25. The outer ring gear 32 comprises, on an inner side 33, a bearing face 36b which rests axially on the plate 21. The support face 36b can extend transversely, preferably perpendicularly, to the second axis A2.

Generally speaking, the outer ring gear 32 comprises, on the inner side 33, a deformation extending at least partially around its periphery so that a peripheral edge 38 of the outer ring gear 32 is at least partially at a distance from the plate 21.

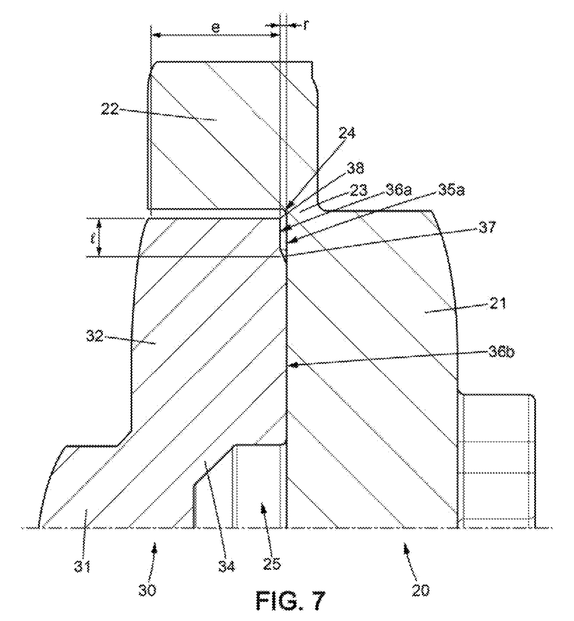

Furthermore, according to a preferred embodiment more particularly visible in FIGS. 7 to 9, the deformation can be peripheral. In this respect, the outer ring gear 32 may comprise, on the inner side 33, a peripheral deformation 35 such that the peripheral edge 38 of the outer ring gear 32 is at a distance from the plate 21. In other words, the outer ring gear 32 comprises a recess 35 (or undercut) located on the periphery of the inner side such that the peripheral edge 38 of the outer ring gear 32 is at a distance away from the plate 21. In particular, the peripheral edge 38 of the outer ring gear 32 can be completely (i.e. in its entirety) at a distance away from the plate 21.

This hinge mechanism 10 configuration provides for better distribution of forces and reduces friction between moving components. By integrating a peripheral deformation 35 on the inner side 33 of the outer ring gear 32, its peripheral edge 38 is kept at a distance from the plate 21. This minimizes direct contact between surfaces, reducing unwanted friction and the risk of premature wear. In addition, this arrangement contributes to a more even distribution of forces during meshing, improving the smoothness of movement and the durability of the mechanism. This design enhances the mechanism's durability and efficiency, while maximizing operating comfort. As a result, operating comfort is maximized thanks to reduced noise and vibration levels.

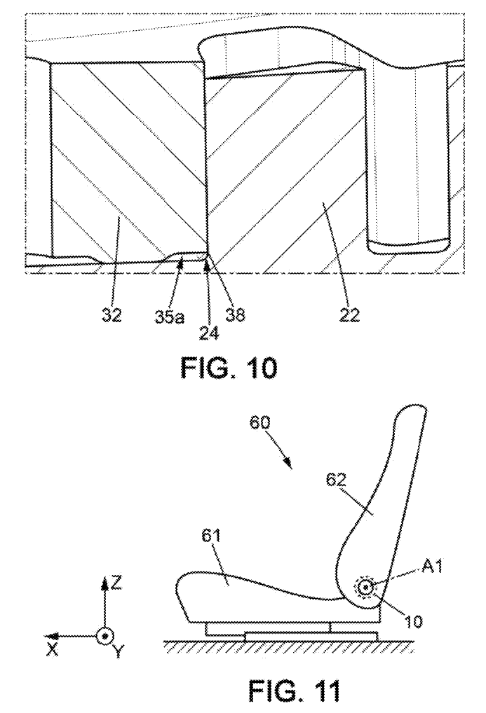

Remarkably, as can be seen in FIGS. 7 and 10, the peripheral edge 38 of the inner side 33 of the outer ring gear 32 is held at a distance from the rounded inner face 24 of the flared annular wall 23. Even if a burr forms on the periphery of the outer ring gear 32 during the manufacturing process, it will not rub against the plate 21 or interfere with the rounded inner face 24 of the flared annular wall 23 between the plate 21 and the inner ring gear 22. The peripheral deformation 35 built into the outer ring gear 32 provides that the peripheral edge 38, where the burr could be located, is kept at a sufficient distance from the plate 21. This configuration prevents unwanted contact, thus avoiding friction and interference that could compromise the mechanism's smooth operation.

In addition, the bearing face 36b of the outer ring gear 32 rests on the plate 21 of the movable flange 20, enabling the outer ring gear 32 and the inner ring gear 22 (and an eccentric cam system 50 described in more detail below) to be arranged and held in the same plane transverse to the axis, which enables torques applied to the backrest 62 to be taken up very effectively without any parasitic torsional effort.

Peripheral deformation 35 is understood to be radially outward with respect to bearing face 36b. It is also understood that the peripheral deformation 35 extends continuously around the entire circumference of the first outer ring gear 32. The peripheral deformation 35 can form a band around the entire circumference of the inner side 33 of the outer ring gear 32.

The inner side 33 of one of the movable flanges 20 and the fixed flange 30 is that side of the flange in the axial direction which faces the other flange axially.

The peripheral edge 38 refers to the outer limit or contour of the outer ring gear 32 on the inner side 33. In this case, the peripheral edge defines the axial profile of the teeth of the outer ring gear 38. By axial profile of the outer ring gear 32, we mean the line of intersection of the teeth (here the peripheral edge 38) with a plane containing the second axis A2. Expressed another way, the peripheral edge 38 is the outermost part that delimits the outer ring gear 32 from the inner side 33.

The outer ring gear may include a burr on the peripheral edge 38, formed in particular during manufacture of the fixed flange 30. As previously mentioned, such a burr, although it may form on the peripheral edge of the outer ring gear during the manufacturing process, is not disruptive in the hinge mechanism. Thanks to the design of the hinge mechanism, which incorporates a peripheral recess, the burr is kept at a sufficient distance from critical surfaces such as the plate. As will be mentioned later, however, the burr can be mitigated by a deburring step.

The peripheral deformation 35 on the inner side 33 of the outer ring gear 32 can be achieved by stamping or pressing. These methods enable the peripheral deformation 35 to be formed in a controlled and uniform manner, thus providing that the peripheral edge 38 of the outer ring gear 32 is correctly positioned at a distance from the plate 21. In addition, the use of these manufacturing techniques contributes to more efficient and reproducible production, which can reduce manufacturing costs and improve the mechanism's reliability over time. More generally, the peripheral deformation 35 can be achieved by crimping the material on the periphery of the inner side of the outer ring gear 32. In other words, the material can be pressed in around the inner side 33 of the outer ring gear 23, in an axial direction away from the plate 21, to reposition the peripheral edge 38 axially further back from an original position. Peripheral deformation 35 can be obtained by plastic deformation of the material.

In this sense, the peripheral deformation 35 is obtained by controlled crimping of the material, comprising the application of sufficient pressure to displace the peripheral edge 38 of the inner side 33 of the outer ring gear 32, axially set back from the bearing face 36b with respect to the plate 21.

The peripheral deformation 35 formed on the inner side 33 of the outer ring gear 32 may comprise a peripheral recess 35a. The peripheral recess 35a may be open radially outwards from the outer ring gear 32.

The peripheral recess 35a can have a peripheral face 36a, the peripheral face 36a being axially set back from the bearing face 36b with respect to the plate 21. The peripheral face 36a may extend transversely to the second axis A2. The peripheral face 36a may be inclined, in whole or in part, with respect to the second axis A2. Alternatively, or in addition, the peripheral face 36a can be perpendicular to the second axis A2.

The outer ring gear 32 may comprise, on the inner side 33, an edge 37 connecting the bearing face 36b to the peripheral face 36a, the edge 37 extending along the periphery of the outer ring gear 32 following the profile of the teeth. In other words, edge 37 can be shown to extend around second axis A2 along a path parallel to the axial profile of outer ring gear 32. Alternatively, edge 37 can extend circularly around second axis A2. Edge 37 can be rounded, chamfered or sharp. Alternatively, edge 37 can form a shoulder.

The outer ring gear 32 may have a thickness e that is smaller radially at the deformation than radially at the bearing face 36b. The outer ring gear 32 may have a thickness e that is smaller radially at the peripheral deformation 35 than radially on the bearing face 36b. The thickness e is considered in the axial direction. Generally speaking, the outer ring gear 32 can have a thickness e of between 3.5 mm and 6 mm, and preferably between 4mm and 5mm.

The peripheral edge 38 of the ring gear may be at an axial distance r from the plate 21 of between 0.1 mm and 0.5 mm, preferably between 0.2 mm and 0.4 mm. In other words, the peripheral recess 35a can have an axial dimension (or depth) of the order of a tenth of a millimeter, and in particular between 0.1 mm and 0.5 mm, preferably between 0.2 mm and 0.4 mm.

The band formed by the peripheral deformation 35 may have a width l of between 0.1 mm and 1 mm. The width l is considered locally in a direction perpendicular to the axial profile of the outer ring gear 32. The width l of the band may be variable (i.e. not constant) around the periphery of the outer ring gear 32. Preferably, however, the width l can be constant around the periphery of the outer ring gear 32.

The hinge mechanism 10 may comprise an eccentric cam system 50 (see FIG. 5) configured to move the contact zone between the internal gear teeth 22 and the external gear teeth 32. The hinge mechanism 10 can be said to be infinitely adjustable, i.e. there is no predefined adjustment increment, all angular positions can be obtained without quantum effect.

For example, one complete turn of the eccentric cam can lead to a one-tooth offset of the inner ring gear 22 relative to the outer ring gear 32, and for example an angular travel of between 10° and 11° between the movable flange 20 and the fixed flange 30.

The eccentric cam system 50 may comprise an actuator, a driver, two wedges (sometimes called sliders) and a spring. In one embodiment, only one wedge shape is possible. The actuator can be either motorized or manually operated.

In the hypocycloid movement that takes place when the eccentric cam system 50 is rotationally adjusted, the first axis A1 and the second axis A2 can rotate relative to each other, while remaining parallel to each other. The distance between the first axis A1 and the second axis A2 can be reduced, for example to between 1 and 2 mm, making the rotational movement between the axes limited and virtually imperceptible to the end user.

Finally, a closing ring 51 (see FIG. 5) can be provided, attached to a peripheral edge of the inner ring gear 22, which holds the movable flange 20 and the fixed flange 30 against each other, allowing relative rotation but preventing translation in the axial direction and rotation transverse to the axial direction. For example, the closure ring 51 can be laser-welded to the peripheral edge of the inner ring gear 22.

With reference to FIG. 11, a seat 60 for a vehicle, in particular a motor vehicle, is now described, comprising the hinge mechanism 10 as described above.

The seat 60 may comprise a squab 61 and a backrest 62, the backrest 62 being connected to the squab 61 by at least one hinge mechanism 10 as described above. More specifically, the squab 61 may comprise a squab 61 frame and the backrest 62 may comprise a backrest 62 frame. The backrest frame 62 can be connected to the seat 60 frame by at least one hinge mechanism 10 as described above.

The first axis A1 and the second axis A2 can extend in a transverse direction Y of the seat 60.

The movable flange 20 may be integral with the backrest 62. The fixed flange 30 may be integral with the squab 61. The backrest 62 can thus pivot relative to the squab 61 about the second axis A2.

A hinge mechanism 10 on the left-hand side of seat 60 and a hinge mechanism 10 on the right-hand side of seat 60 may be provided, linked together by a control bar.

The movable flange 20 and fixed flange 30 of the hinge mechanism 10 can be attached to the backrest 62 and squab 61 respectively by laser welding (or MAG arc welding). For this purpose, the movable flange 20 and the fixed flange 30 may comprise an annular series of fastening reliefs 26; 39 each projecting from the respective plate 21; 31 and intended to fasten them. Alternatively or in addition, at least one of the following fastening techniques can be used: welding, screwing, riveting and gluing.

The outer diameter of the hinge mechanism 10 can be up to 100 mm. In one example, the outer diameter of the hinge mechanism 10 can be between 65 mm and 95 mm. The thickness of the hinge mechanism 10 may be less than 20 mm, or less than 10 mm. This provides easy integration of the hinge mechanism 10 into the seat 60.

The seat 60 may comprise a geared motor, in particular for rotating the eccentric cam system 50. In this case, the hinge mechanism 10 is motor-driven. In the case of manual operation, a user can turn a handle of the seat 60, which is rotationally fixed to the eccentric cam system 50.

The hinge mechanism 10 can be adapted to a seat 60 comprising a seatbelt anchoring point located on the backrest 62 of the seat 60, which makes it more critical to withstand the forces experienced in the event of an impact encountered by the vehicle. However, the hinge mechanism 10 is also suitable for a seat 60 comprising a seatbelt anchoring point located on a pillar of the vehicle wherein the seat 60 is installed.

A method for manufacturing the fixed flange 30, in particular for the hinge mechanism as described above, is now described. The method comprises:

/A/ Cutting a flat metal blank to form the outer ring gear 32 of the fixed flange 30, with, on an inner side 33, the bearing face 36b which is intended to bear axially on the plate 21 of the movable flange 20 whose inner ring gear 22 meshes with the outer ring gear 32,

/B/ Applying pressure to a peripheral zone of the inner side 33 of the outer ring gear 32 so as to create, on the inner side 33, the deformation, here peripheral (i.e. peripheral deformation 35), intended to move the peripheral edge 38 of the outer ring gear 32 away from the plate 21 when the bearing face 36b is axially bearing on the plate 21 of the movable flange 20.

The cutting (/A/) and peripheral deformation (/B/) steps can be performed simultaneously. Alternatively, the cutting (/A/) and peripheral deformation (/B/) steps can be carried out successively in any order (/A/ then /B/, or /B/ then /A/).

Performing the cutting and peripheral deformation steps simultaneously means that the deformation can be integrated into the inner side of the outer ring gear 32 without requiring additional steps in the manufacturing process. This approach provides that production times are not lengthened, as both operations are carried out in a single pass. Moreover, by avoiding the need for separate deformation steps, production costs remain unchanged. This method thus maximizes the efficiency of the manufacturing process, while keeping production costs and lead times at a competitive level, which is particularly advantageous for the mass production of hinge mechanisms 10.

The peripheral cutting and deformation steps can be carried out simultaneously using a fine-cutting method. In particular, the peripheral cutting and shaping steps can be carried out simultaneously in the following subsidiary steps:

Placing the metal blank on a die comprising a negative impression of the outer ring gear 32 to be formed,

- Applying pressure to the metal blank with a punch having a shape corresponding to the outer contours of the outer ring gear 32, the pressure being exerted opposite the die impression, so as to cut the outer ring gear 32, the pressure being exerted on a face of the metal blank intended to coincide with the inner side 33 of the outer ring gear 32, the punch comprising a projecting relief applied to the face of the blank so that the pressure exerted by the punch on the metal blank creates the deformation, here peripheral, on the inner side 33 of the outer ring gear 32.

More generally, the fine-cutting method used in the manufacture of the fixed flange 30 can be used to form other aspects of the fixed flange 30 described above (e.g. the plate 21, or the fastening reliefs 26; 39). In this sense, the fine-cutting method may comprise one or more die-cutting operation(s) before or after, each of which comprises:

Placing the metal blank on a die comprising a negative impression of the shape or relief to be produced,

Applying pressure by means of a punch whose shape corresponds to the contours of the shape or relief to be produced, said pressure being exerted opposite the die impression, so as to cut or create the desired shape or relief.

The fine-cutting method results in a blank fixed flange 30. The manufacturing method may comprise subsequent heat treatment and/or deburring steps to produce a fixed flange 30 ready for assembly in the hinge mechanism 10 as described above. Furthermore, according to another aspect, a method for manufacturing the hinge mechanism is proposed as described above, during which the method for manufacturing the fixed flange 30 is implemented. The method for manufacturing the hinge mechanism may comprise the assembling of the fixed flange and the movable flange, in particular by meshing the outer ring gear with the inner ring gear. The method for manufacturing the hinge mechanism may further comprise the assembly of the eccentric cam system, and preferably the assembly of the locking ring. These assembly steps can be carried out successively in any order, or simultaneously (for example, the fixed flange, movable flange and eccentric cam system can be assembled in a single step).

The present disclosure is not limited to the examples described above and is subject to numerous variants.

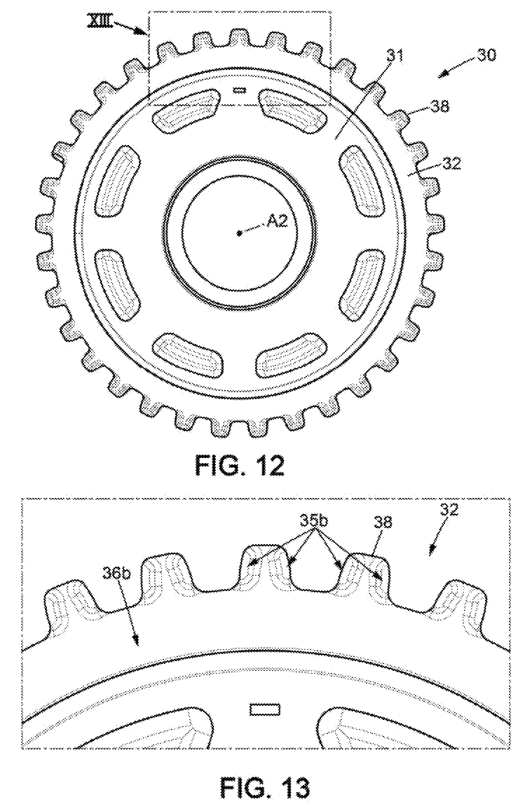

According to a variant shown in FIGS. 12 and 13, the deformation may comprise a recess 35b located on each tooth flank of the toothing outer ring gear 32. Alternatively, each recess 35b extends along a tooth flank of one of the teeth of the outer ring gear 32. Each tooth of the outer ring gear 32 may comprise, on the inner side 33, a recess on each side on each of the flanks. The addendum and dedendum zones of each tooth of the outer ring gear 32 may be free of recesses. The result is an annular series of individual recesses 35b. Each recess 35b opens onto the corresponding tooth flank.

In particular, this variant avoids interference between the peripheral edge 38 of the outer ring gear 32 and the rounded inner face 24 of the flared annular wall 245 of the movable flange 20, in the engagement zones between the outer ring gear 32 and the inner ring gear 22.

Comparative continuously adjustable hinge mechanisms 100 for vehicle seats may be used for adjusting the inclination of the seat backrest relative to the squab. Such comparative hinge mechanisms 100 can be manually or motor-operated.

Such a comparative hinge mechanism 100 uses a hypocycloid gear mechanism, wherein an eccentric cam system is rotated by a motorized or manually operated actuator.

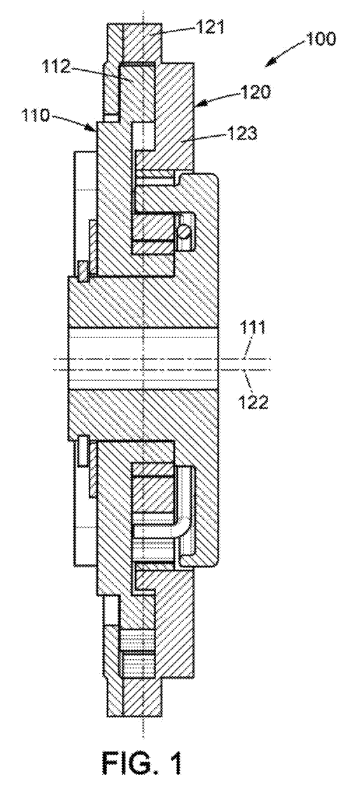

With reference to FIG. 1, the comparative hinge mechanism 100 comprises a first flange 110 and a second flange 120 mounted to be rotatable relative to each other and connected by the hypocycloid gear mechanism. To this end, the first flange 110 comprises a first outer ring gear 112, centered on a first axis 111, and the second flange 120 comprises a second inner ring gear 121, centered on a second axis 122 parallel to the first axis 111 and offset from the first axis 111. The first ring gear 112 and the second ring gear 121 mesh with each other, forming the hypocycloidal gear mechanism. For compactness and to provide flange alignment, the first ring gear 112 is arranged to rest directly on a side surface 123 of the second flange 120.

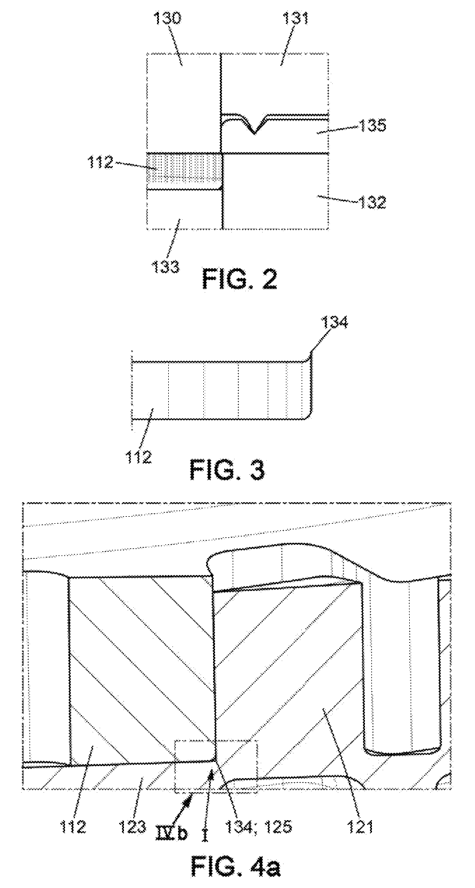

In addition, the first flange 110 and the second flange 120 may be manufactured using a fine cutting method. To this end, as shown in FIG. 2, a punch 130 exerts pressure to cut a sheet 135, while a clamp 131 holds the part firmly in place to prevent movement or deformation. The sheet is supported by a die 132, which corresponds to the negative imprint of the blank. Once cutting is complete, an ejector 133 ejects the cut part from the die 132 to release the tool and enable a new cycle. The method may comprise one or more fine-cutting steps to manufacture the first flange 110 and the second flange 120. Each step may be configured to form one or more reliefs on the corresponding flange. For example, one of the steps may be configured to form at least the ring gear of the corresponding flange.

Although this comparative method offers significant benefits in terms of manufacturing tolerances and the flatness of the parts produced, it has the disadvantage of generating burrs around the edges of the manufactured parts. The burr is a small protrusion or irregular ridge of material that forms on the edges of the cut sheet, mainly on the side opposite the entry of the punch 130. It results from plastic deformation and incomplete shearing of the material during cutting.

Such a burr 134 therefore appears on the periphery of one of the faces of the first ring gear 112 when it is cut (see FIG. 3). Furthermore, due to manufacturing constraints for the first flange 110, the face of the first ring gear 112 on which the burr 134 is formed happens to correspond to the face bearing on the side surface of the second flange 120.

It has been observed that such a configuration has several notable drawbacks. The burr 134 on the first ring gear 112 comes into contact with the second flange 120 and rubs against it during rotation between the first flange 110 and the second flange 120. This constant friction can not only cause damage to the hypocycloid gear mechanism, but also lead to premature wear of the second flange 120. In addition, this undesirable contact generates noise which can be annoying to the occupant, compromising the comfort of the seat occupant and the quality of use of the hinge mechanism 100.

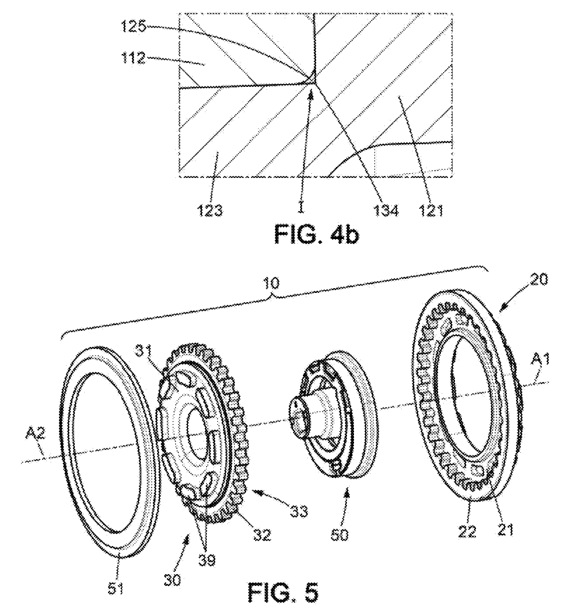

Furthermore, as shown in FIGS. 4a and 4b, it has been found that such an irregular burr 134 on the periphery of the first ring gear 112 interferes I (i.e. comes into contact or collides) with a connecting rounding 125 between the second ring gear 121 and the side surface of the second flange 120, which can cause not only impacts between the first ring gear 112 and the second flange 120, but also damage over time. In addition, this interference creates uneven contact points, disrupting the uniform distribution of forces between the tooth flanks of the first ring gear 112 and the second ring gear 121. As a result, areas of localized pressure can lead to premature wear or damage to contact surfaces. In addition, poor contact reduces the efficiency of motion transmission and can generate unwanted vibrations or noise.

Proposed is a hinge mechanism for a seat comprising:

a movable flange comprising a plate and an inner ring gear, the inner ring gear being centered on a first axis,

a fixed flange comprising an outer ring gear centered on a second axis parallel to the first axis and meshing with the inner ring gear of the movable flange, the outer ring gear comprising, on an inner side, a bearing face which bears axially on the plate,

wherein the outer ring gear comprises, on the inner side, a deformation extending at least partially over its periphery, so that a peripheral edge of the outer ring gear is at least partially at a distance from the plate.

The outer ring gear may comprise a peripheral deformation on the inner side, such that a peripheral edge of the outer ring gear is entirely at a distance away from the plate.

The peripheral deformation on the inner side of the outer ring gear may comprise a peripheral recess.

The peripheral recess can have a peripheral face, the peripheral face being axially set back from the bearing face with respect to the plate.

The outer ring gear may comprise, on the inner side, an edge connecting the bearing face to the peripheral face, the edge extending along the periphery of the outer ring gear following the profile of the teeth.

The peripheral deformation can form a band around the inner side of the outer ring gear with a width of between 0.1 mm and 1 mm.

The deformation can be localized at each tooth flank of the teeth of the outer ring gear.

The outer ring gear may have a thickness that is smaller radially at the deformation than radially at the bearing face.

The peripheral edge of the ring gear can be wholly or partially at an axial distance from the plate of between 0.1 mm and 0.5 mm, preferably between 0.2 mm and 0.4 mm.

According to another aspect, a vehicle seat is proposed, particularly for a motor vehicle, comprising the hinge mechanism as described above.

According to another aspect, a method for manufacturing a fixed flange for a seat hinge mechanism is proposed, the method comprising:

Cutting a flat metal blank to form an outer ring gear of the fixed flange, which comprises, on an inner side, a bearing face that is intended to bear axially on a plate of a movable flange that comprises an inner ring gear meshing with the outer ring gear,

Applying pressure to a peripheral zone of the inner side of the outer ring gear so as to create, on the inner side, a peripheral deformation intended to move a peripheral edge of the outer ring gear away from the plate when the bearing face is axially bearing on a plate of a movable flange which comprises an inner ring gear meshing with the outer ring gear.

The present disclosure relates to a hinge mechanism (10) for a seat comprising a movable flange (20) comprising a plate (21) and an inner ring gear (22), the inner ring gear (22) being centered on a first axis (A1), and a fixed flange (30) comprising an outer ring gear (32) centered on a second axis (A2) parallel to the first axis (A1) and meshing with the inner ring gear (22) of the movable flange (20), the outer ring gear (32) comprising, on an inner side (33), a bearing face (36b) which bears axially on the plate (21), wherein the outer ring gear (32) comprises, on the inner side (33), a deformation extending at least partially over its periphery so that a peripheral edge (38) of the outer ring gear (32) is at least partially at a distance from the plate (21).

1. A hinge mechanism for a seat comprising:
a movable flange comprising a plate and an inner ring gear, the inner ring gear being centered on a first axis,
a fixed flange comprising an outer ring gear centered on a second axis parallel to the first axis and meshing with the inner ring gear of the movable flange, the outer ring gear comprising, at an inner side, a bearing face which bears axially on the plate,
wherein the outer ring gear comprises, on the inner side, a deformation extending at least partially around its periphery so that a peripheral edge of the outer ring gear is at least partially at a distance from the plate.

2. The mechanism of claim 1, wherein the outer ring gear comprises, on the inner side, a peripheral deformation such that the peripheral edge of the outer ring gear is entirely at a distance away from the plate.

3. The mechanism of claim 2, wherein the peripheral deformation at the inner side of the outer ring gear comprises a peripheral recess.

4. The mechanism of claim 3, wherein the peripheral recess has a peripheral face, the peripheral face being axially set back from the bearing face with respect to the plate.

5. The mechanism of claim 4, wherein the outer ring gear comprises, on the inner side, an edge connecting the bearing face to the peripheral face, the edge extending along the periphery of the outer ring gear following the profile of the teeth.

6. The mechanism of claim 2, wherein the peripheral deformation forms a band around the inner side of the outer ring gear having a width of between 0.1 mm and 1 mm.

7. The mechanism of claim 1, wherein the deformation comprises a recess located on each tooth flank of the toothing of the outer ring gear.

8. The mechanism of claim 1, wherein the outer ring gear has a thickness which is smaller radially at the deformation than radially at the bearing face.

9. The mechanism of claim 1, wherein the peripheral edge of the ring gear is, in whole or in part, at an axial distance from the plate of between 0.1 mm and 0.5 mm, preferably between 0.2 mm and 0.4 mm.

10. A vehicle seat, in particular for a motor vehicle, comprising the hinge mechanism according to claim 1.

11. A method for manufacturing a fixed flange for a seat hinge mechanism, the method comprising:
cutting a flat metal blank to form the outer ring gear of the fixed flange, with, on an inner side, a bearing face which is intended to bear axially on a plate of the movable flange which comprises an inner ring gear meshing with the outer ring gear,
applying pressure to a peripheral zone of the inner side of the outer ring gear so as to create, on the inner side, a peripheral deformation, intended to move a peripheral edge of the outer ring gear away from the plate when the bearing face is axially bearing on a plate of a movable flange which comprises an inner ring gear meshing with the outer ring gear.
